(19) United States
(12) Patent Application Publication
(10) Pub. No.: US 2025/0319739 A1
(43) Pub. Date: Oct. 16, 2025

(54) COOLANT-LOOP BASED HEAT PUMP FOR VEHICLE THERMAL MANAGEMENT

(71) Applicant: GM GLOBAL TECHNOLOGY OPERATIONS LLC, Detroit, MI (US)

(72) Inventors: Vijayakanthan Damodaran, Windsor (CA); Jilin Zhang, Bloomfield Hills, MI (US); Vasile Hasnas, Sterling Heights, MI (US); Diwakar Natarajan, Windsor (CA); Anurag Dhengre, Farmington Hills, MI (US); Devin C. Richardson, Novi, MI (US); Daniel R. Tylutki, Livonia, MI (US)

(73) Assignee: GM GLOBAL TECHNOLOGY OPERATIONS LLC, Detroit, MI (US)

(21) Appl. No.: 18/632,868

(22) Filed: Apr. 11, 2024

(51) Int. Cl. B60H 1/00; B60H 1/32; B60K 11/02; B60L 58/26

(52) U.S. Cl. CPC B60H 1/00392; B60H 1/00278; B60H 1/3211; B60H 1/32281; B60L 58/26; B60H 2001/00307; B60H 2001/325; B60H 2001/3288; B60K 11/02

(57) ABSTRACT

A thermal management system for an electric vehicle includes a coolant loop having a pump configured to circulate a coolant in the coolant loop and one or more valves. A controller is adapted to control respective positions of the one or more valves for modifying the coolant pathway in the coolant loop. The system includes a coolant-to-refrigerant (C2R) heat exchanger fluidly connected to the coolant loop and a refrigerant loop. A low-temperature radiator is located in the coolant loop downstream of the C2R heat exchanger. A coolant heater is positioned in the coolant loop downstream of the low-temperature radiator and a compressor is located in the refrigerant loop. The controller is adapted to minimize energy usage for cabin heating in the electric vehicle by minimizing a respective load of the coolant heater, maximizing the respective load of the compressor, and maintaining a threshold suction pressure for compressor operation.

### INTRODUCTION

The present disclosure relates generally to a thermal management system for an electric vehicle. More specifically, the disclosure relates to a coolant-loop based heat pump for thermal management in an electric vehicle. The use of mobile platforms employing a rechargeable energy source, both as an exclusive source of energy and a non-exclusive source of energy, has greatly increased over the last few years. A rechargeable energy storage device with battery packs may store and release electrochemical energy as needed during a given operating mode. The electrochemical energy may be employed for propulsion, heating or cooling a cabin compartment, powering vehicle accessories and other uses. During cold weather, a relatively greater amount of energy may be used up for heating the cabin compartment.

### SUMMARY

Disclosed herein is a thermal management system for an electric vehicle. The system includes a coolant loop having a pump configured to circulate a coolant in the coolant loop and one or more valves. A controller is adapted to control respective positions of the one or more valves for modifying the coolant pathway in the coolant loop. The controller has a processor and tangible, non-transitory memory on which instructions are recorded. A coolant-to-refrigerant (C2R) heat exchanger is fluidly connected to the coolant loop and a refrigerant loop. The C2R heat exchanger is configured to transfer heat between the coolant circulating in the coolant loop and a refrigerant circulating in the refrigerant loop.

A low-temperature radiator is located in the coolant loop downstream of the C2R heat exchanger. The low-temperature radiator is adapted to extract heat from ambient air to warm the coolant when a coolant temperature is lower than an ambient temperature. A coolant heater is located in the coolant loop downstream of the low-temperature radiator and a compressor is located in the refrigerant loop. The controller is adapted to minimize energy usage for cabin heating in the electric vehicle by minimizing a respective load of the coolant heater, maximizing the respective load of the compressor, and maintaining a threshold suction pressure for compressor operation.

In some embodiments, the threshold suction pressure is between 120 and 140 Kilopascals, and the target load for the compressor is between 4000 and 5000 revolutions-per-minute. The controller is adapted to identify a target temperature for the coolant at a respective inlet of the C2R heat exchanger, in response to input signals indicative of a demand for the cabin heating. The controller is adapted to increase the respective load of the coolant when a coolant temperature at the respective inlet of the C2R heat exchanger is at or above the target temperature. The target temperature may be between −5 degrees Celsius and −9 degrees Celsius.

The controller may be adapted to direct the coolant path to flow through the low-temperature radiator when the coolant temperature at a respective inlet of the low-temperature radiator is less than the ambient temperature. The controller may be adapted to direct the coolant path to bypass the low-temperature radiator when the coolant temperature at the respective inlet of the low-temperature radiator is at or above the ambient temperature. The controller may be adapted to increase a compressor load if a low-side refrigerant pressure is at or above the threshold suction pressure and decrease the compressor load if the low-side refrigerant pressure is below the threshold suction pressure.

The system may include a rechargeable energy storage system (RESS) section located in the coolant loop downstream of the low-temperature radiator, the RESS section having a traction battery pack. The controller may be adapted to direct the coolant path to flow through the RESS section when the coolant temperature at a respective inlet of the RESS section is less than a RESS temperature, the coolant receiving heat from the RESS section. The controller may be adapted to direct the coolant path to bypass the RESS section when the coolant temperature at the respective inlet of the RESS section is at or above the RESS temperature.

A power electronics (PE) section may be located in the coolant loop downstream of the low-temperature radiator. The controller may be adapted to direct the coolant path to flow through the PE section when the coolant temperature at a respective inlet of the PE section is less than a PE section temperature, the coolant receiving heat from the PE section. The controller may be adapted to direct the coolant path to bypass the PE section when the coolant temperature at the respective inlet of the PE section is at or above the PE section temperature.

The system may include a surge tank adapted to store additional coolant, the controller being adapted to selectively draw the additional coolant into the coolant loop. In some embodiments, a condensing heater is located in the refrigerant loop downstream of the compressor, the condensing heater being adapted to transmit heat to a vehicle cabin.

Disclosed herein is a method for thermal management in an electric vehicle having a controller with a processor and tangible, non-transitory memory and a coolant loop. The method includes circulating a coolant in the coolant loop via a pump, the coolant loop having one or more valves. The method includes modifying a coolant pathway by controlling a respective position of the one or more valves, via the controller. The method includes transferring heat between the coolant circulating in the coolant loop and a refrigerant circulating in a refrigerant loop through a coolant-to-refrigerant (C2R) heat exchanger fluidly connected to the coolant loop and the refrigerant loop. The method includes extracting heat from ambient air to warm the coolant when a coolant temperature is lower than an ambient temperature through a low-temperature radiator located in the coolant loop downstream of the C2R heat exchanger. The method includes positioning a coolant heater in the coolant loop downstream of the low-temperature radiator and positioning a compressor in the refrigerant loop. The method includes minimizing energy usage for cabin heating in the electric vehicle by minimizing a respective load of the coolant heater, maximizing the respective load of the compressor, and maintaining a threshold suction pressure for compressor operation, via the controller.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a coolant-based heat pump system in a vehicle, the system having a controller;

FIG. 2 is a schematic flow diagram of a method executable by the controller of FIG. 1;

FIG. 3 is a schematic diagram of a portion of the system of FIG. 1; and

FIG. 4 is a schematic graph of pressure relative to enthalpy in a refrigeration cycle.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

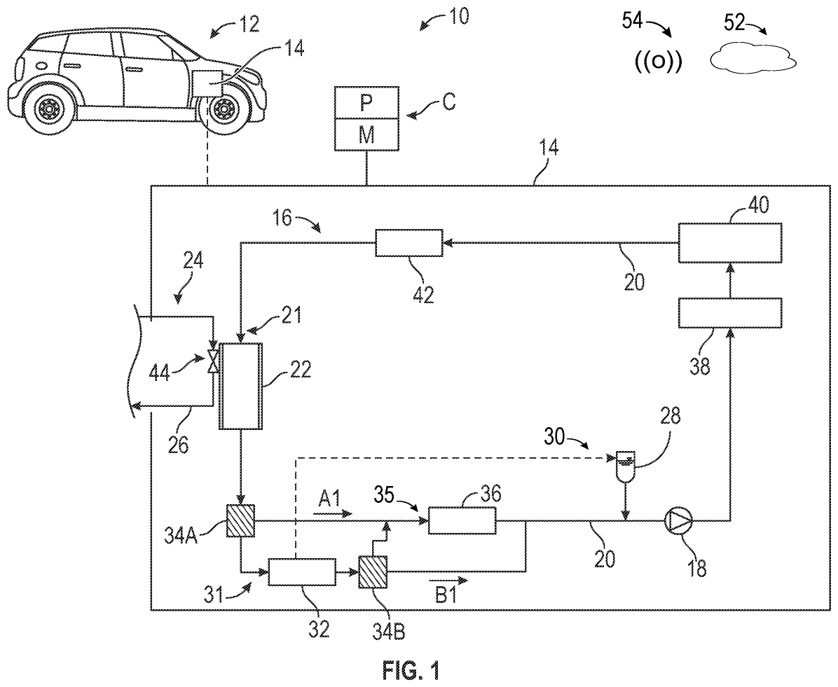

Referring to the drawings, wherein like reference numbers refer to like components, FIG. 1 schematically illustrates a thermal management system 10 (hereinafter “system”) for an electric vehicle 12. As described below, the system 10 includes a coolant-loop based heat-pump 14 that improves the range of the electric vehicle 12 during cold ambient conditions. The electric vehicle 12 may be partially electric or fully electric. The electric vehicle 12 may be a mobile platform, such as, but not limited to, a passenger vehicle, sport utility vehicle, light truck, heavy duty vehicle, ATV, minivan, bus, transit vehicle, bicycle, moving robot, farm implement (e.g., tractor), sports-related equipment (e.g., golf cart), boat, plane, and train. It is to be understood that the electric vehicle 12 may take many different forms.

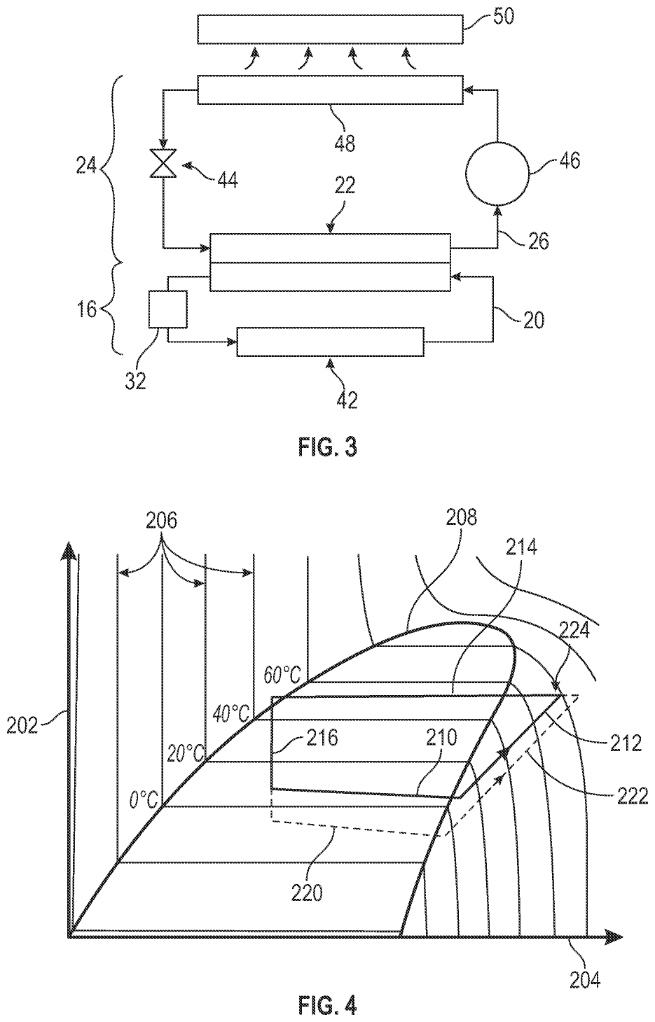

Referring to FIG. 1, the coolant loop 16 includes a pump 18 configured to circulate a coolant 20 in the coolant loop 16. The coolant 20 may be a water-based coolant containing additives for various purposes (e.g., anti-freeze). The coolant loop may employ oil-based coolants. In one embodiment, coolant 20 is ethylene glycol. FIG. 3 shows a portion of the system 10. Referring to FIGS. 1 and 3, a coolant-to-refrigerant (C2R) heat exchanger 22 (also referred to as chiller 22) is fluidly connected to the coolant loop 16 and a refrigerant loop 24. The C2R heat exchanger 22 is configured to transfer heat between the coolant circulating in the coolant loop and a refrigerant 26 circulating in the refrigerant loop. In some embodiments, the C2R heat exchanger 22 is a compact plate-to-plate heat exchanger.

Referring to FIG. 1, the coolant loop 16 includes a surge tank 28 that acts as a regulating component for the amount of coolant 20 in the coolant loop 16. Coolant overflow may be directed towards the surge tank 28 via path 30. Referring to FIGS. 1 and 3, a low-temperature radiator 32 is located downstream of the C2R heat exchanger 22. As described below, the low-temperature radiator 32 is adapted to extract heat from ambient air to warm the coolant 20 circulating in the coolant loop when the coolant temperature is lower than the ambient temperature. The low-temperature radiator 32 may be constructed with channels or pipes for the coolant to circulate therein, along with metal fins to aid in heat transfer.

As understood by those skilled in the art, a low-temperature radiator operates at a lower temperature range than a regular radiator. For example, a low-temperature radiator 32 may be adapted to operate in a range of about 25 degrees Celsius to 60 degrees Celsius. In one embodiment, the low-temperature radiator 32 has a range of operation of 40 to 50 degrees Celsius.

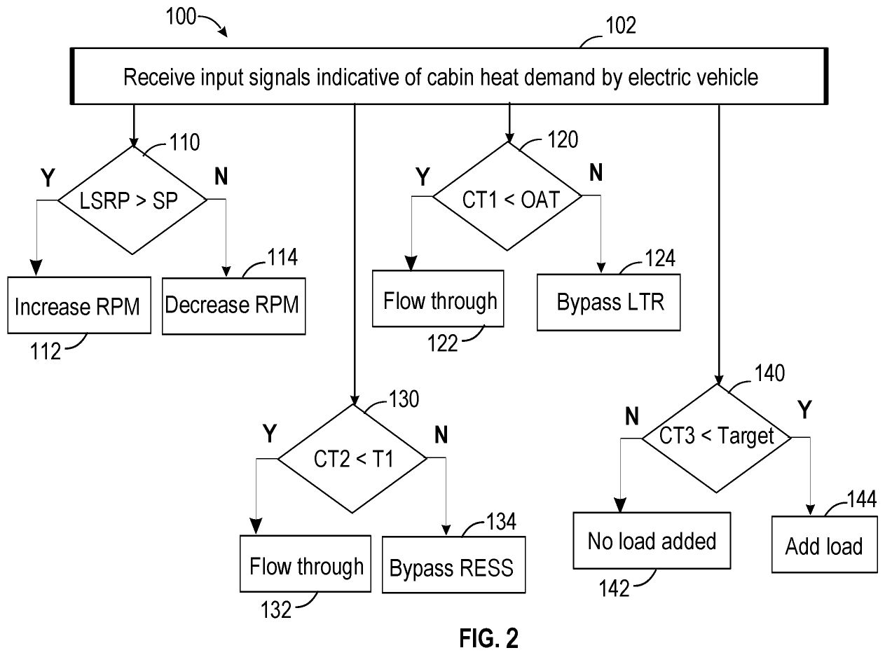

Referring to FIG. 1, the system 10 includes a controller C with at least one processor P and at least one memory M (or non-transitory, tangible computer readable storage medium) on which instructions are recorded for executing a method 100 for operating the coolant-loop based heat-pump 14, described below with respect to FIG. 2. The memory M can store executable instruction sets, and the processor P can execute the instruction sets stored in the memory M.

Referring to FIG. 1, the coolant loop 16 includes one or more valves (e.g., first valve 34A and second valve 34B) each having a respective variable position. The controller C is adapted to adjust or control the respective position of the valves to modifying the path of the coolant along the coolant loop 16, referred to herein as the coolant pathway. For example, the controller C is adapted to modify the position of the first valve 34A to direct the coolant path to bypass the low-temperature radiator 32 (through coolant pathway A1) when the coolant temperature at the inlet 31 of the low-temperature radiator 32 is at or above the ambient temperature.

Referring to FIG. 1, the coolant loop 16 includes a rechargeable energy storage system (referred to herein as RESS section 36) having a traction battery pack that is used to power the electric vehicle 12. The battery cells in the RESS section 36 may have different chemistries, including but not limited to, lithium-ion, lithium-iron, nickel metal hydride and lead acid batteries. It is understood that the configuration, number and type of battery cells in the RESS section 36 may be varied based on the application at hand.

Referring to FIG. 1, a powertrain drive unit (PDU) 38 and a power electronics (PE) section 40 are each positioned downstream of the low-temperature radiator 32 in the coolant loop. The PDU 38 includes an electric motor (not shown) transmitting torque to the wheels of the electric vehicle 12. The PE section 40 generally includes a traction power inverter module, an accessory power module, and/or an onboard charging module (not shown).

Referring to FIGS. 1 and 3, a coolant heater 42 is positioned in the coolant loop 16 downstream of the low-temperature radiator 32. The refrigerant loop 24 includes an expansion valve 44 adapted to control the flow of refrigerant 26, shown in FIGS. 1 and 3. The expansion valve 44 may further lower the pressure on the refrigerant 26.

Referring to FIG. 3, the refrigerant loop 24 includes a compressor 46 located downstream of the C2R heat exchanger 22. The compressor 46 squeezes the refrigerant 26, turning it into a heated, high-pressured gas that is pumped into a condensing heater 48. As the refrigerant 26 moves through the condensing heater 48, converting to a gas from a liquid, heat is released and vented into the vehicle cabin 50. The high-voltage accessory load for cabin heating is a combination of the compressor load and the coolant heater load. Thus, there is a tradeoff between compressor load in high-speed compressor operation in a refrigeration loop 24 compared to the resistive load of the coolant heater 42 in the coolant loop 16 for cabin heating.

The controller C is adapted to minimize energy usage by minimizing a respective load of the coolant heater 42, maximizing the respective load of the compressor 46, and maintaining a threshold suction pressure for compressor operation. Since the refrigerant loop 24 is relatively more efficient, this mode of operation reduces the overall high-voltage accessory load expended for cabin heating.

The system 10 identifies a target temperature for the coolant 20 at the inlet 21 of the C2R heat exchanger 22, in response to input signals indicative of a cabin heat demand by the electric vehicle 12. The coolant heater load is increased when a coolant temperature at the inlet 21 of the C2R heat exchanger 22 is at or above the target temperature. The controller C determines the target temperature based on the demand for cabin heating in the electric vehicle 12 and the specification of the various components in the heat pump 14, using a calibration process or simulation/modeling process available to those skilled in the art. The target temperature may be between −5 degrees Celsius and −9 degrees Celsius. In one example, the target temperature is about-7 degrees Celsius.

As discussed below, the system 10 involves changes in mechanization of the coolant loop 16 as well as a mode of operation to ensure that the coolant temperature rises before arriving at the inlet 21 of the C2F exchanger 22, either from ambient heat through the low-temperature radiator 32, and/or waste heat from the RESS section 36 or powertrain drive unit 38 or power electronics section 40.

Referring now to FIG. 2, a flowchart of the method 100 stored on and executable by the controller C of FIG. 1 is shown. Method 100 may be embodied as computer-readable code or instructions stored on and partially executable by the controller C of FIG. 1. Method 100 need not be applied in the specific order recited herein. Furthermore, it is to be understood that some steps may be eliminated. The method 100 may be dynamically executed. The method 100 is not tied to a particular type, or configuration of the components described above, e.g., low-temperature radiator 32, compressor 46 etc.

Per block 102 of FIG. 2, the controller C is adapted to receive input signals indicative of a cabin heat demand by the electric vehicle 12, e.g., for the cabin. Cabin heating is a function of the discharge pressure of the refrigerant, which is achieved through the respective load of the coolant heater and the compressor. From block 102, the method 100 may concurrently proceed to one or more of blocks 110, 120, 130, and 140, to respectively manage compressor operation, low-temperature radiator bypass operation, RESS bypass operation, and coolant heater operation.

Per block 110, the controller C is adapted to determine if a low side refrigerant pressure (LSRP) is at or above a threshold suction pressure (SP). If so (block 110=YES), the method 100 advances to block 112 where the controller C is adapted to increase the compressor load. If the low-side refrigerant pressure is below the threshold suction pressure (block 110=NO), the controller C is adapted to decrease the compressor load, per block 114.

Per block 120, the controller C is adapted to determine if the coolant temperature (CT1) at the inlet 31 of the low-temperature radiator 32 is less than the outside ambient temperature (OAT), referred to here as ambient temperature. If so (block 120=YES), the method 100 advances to block 122 where the controller C is adapted to direct the coolant path to flow through the low-temperature radiator 32, the coolant receiving heat. If the coolant temperature at the inlet 31 of the low-temperature radiator 32 is at or above the ambient temperature (block 120=NO), the controller C is adapted to modify the position of the first valve 34A to direct the coolant path to bypass the low-temperature radiator 32 (through coolant pathway A1) when the coolant temperature at the inlet 31 of the low-temperature radiator 32 is at or above the ambient temperature, per block 124.

Per block 130, the controller C is adapted to determine if the coolant temperature (CT2) at the inlet 35 of the RESS section 36 is less than the RESS temperature (T1). If so (block 130=YES), the method 100 advances to block 132 where the controller C is adapted to direct the coolant path to flows through the RESS section, with the coolant receiving waste heat from the RESS section. If not (block 130=NO), the controller C is adapted to modify the position of the second valve 34B to direct the coolant path to bypass the RESS section 36 (through coolant pathway B1), per block 134.

Per block 140, the controller C is adapted to determine if a coolant temperature (CT3) at the inlet 21 of the C2R heat exchanger 22 is less than a target temperature. If so (block 140=YES), the controller C is adapted to increase the respective load of the coolant heater 42, per block 144. If not (block 140=NO), the method 100 advances to block 142 where the controller C is adapted to retain (or not increase) the respective load of the coolant heater 42. Method 100 may be repeated continuously, or at predefined time intervals, during operation of the vehicle 12.

Energy benefits may be obtained during an initial stage of heat pump operation by extracting heat from an increased coolant volume in the coolant loop 16, for example, by increasing the size of the surge tank 28. The controller C is adapted to selectively draw the excess coolant into the coolant loop 16 to improve heat pump operation by reducing the high-voltage accessory load. For example, an additional ten liters may ensure heating for approximately 2 minutes, and twenty liters may ensure heating for approximately 3 minutes.

Referring now to FIG. 4, is a schematic graph of vertical axis 202 denoting pressure (in atmospheric bar) and the horizontal axis 204 denoting enthalpy in kilojoules per kilogram (KJ/kg). The various temperatures (e.g., 0, 20, 40, and 60 degrees Celsius) are indicated by contours 206. Curve 208 separates various phases (e.g., liquid, solid) of a refrigerant. As shown in FIG. 4, trace 210 indicates an evaporation process with the coolant temperature at the respective inlet of the C2R heat exchanger being about 15 degrees Celsius. Trace 212 indicates a compression process with the compressor load being 2000 RPM. Trace 214 and trace 216 respectively indicate a condensation and an expansion process. Trace 214 indicates an air-in temperature of −7 degrees Celsius and an air-out temperature of 45 degrees Celsius.

The system 10 enables an energy minimizing path, shown by (dashed) lines 220 and 222 in FIG. 4. Line 220 indicates an evaporation process with the coolant temperature at the respective inlet of the C2R heat exchanger being about-7 degrees Celsius. Line 222 indicates a compression process with the compressor load being 4500 RPM, reaching trace 214 at point 224. Thus, the system 10 minimizes energy usage by minimizing the respective load of the coolant heater, maximizing the respective load of the compressor, and maintaining a threshold suction pressure for compressor operation.

Referring to FIG. 1, the controller C may be configured to communicate with or access data from a cloud unit 52, via the wireless network 54. The cloud unit 52 may include one or more servers hosted on the Internet to store, manage, and process data. The wireless network 54 of FIG. 1 may be a Wireless Local Area Network (LAN) which links multiple devices using a wireless distribution method, a Wireless Metropolitan Area Networks (MAN) which connects several wireless LANs or a Wireless Wide Area Network (WAN) which covers large areas such as neighboring towns and cities. The wireless network 54 may be WIFI or a Bluetooth™ connection, defined as being a short-range radio technology (or wireless technology) aimed at simplifying communications among Internet devices and between devices and the Internet. Other types of connections may be employed.

In summary, the system 10 (via execution of method 100) enables a heat-pump mode operation strategy developed for cabin heating during cold ambient conditions. The system 10 reduces voltage load, resulting in an increase in range for the electric vehicle 12 in those cold conditions. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 may be an integral portion of, or a separate module operatively connected to, other controllers of the electric vehicle 12. The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database energy system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowchart(s) shown in the FIGS. illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A thermal management system for an electric vehicle, the system comprising:
a coolant loop having a pump configured to circulate a coolant in the coolant loop and one or more valves;
a controller adapted to control a respective position of the one or more valves for modifying a coolant pathway, the controller having a processor and tangible, non-transitory memory on which instructions are recorded;
a coolant-to-refrigerant (C2R) heat exchanger fluidly connected to the coolant loop and a refrigerant loop, the C2R heat exchanger being configured to transfer heat between the coolant circulating in the coolant loop and a refrigerant circulating in the refrigerant loop;
a low-temperature radiator located in the coolant loop downstream of the C2R heat exchanger, the low-temperature radiator being adapted to extract heat from ambient air to warm the coolant when a coolant temperature is lower than an ambient temperature;
a compressor located in the refrigerant loop and a coolant heater located in the coolant loop downstream of the low-temperature radiator; and
wherein the controller is adapted to minimize energy usage for cabin heating in the electric vehicle by minimizing a respective load of the coolant heater, maximizing the respective load of the compressor, and maintaining a threshold suction pressure for compressor operation.

2. The system of claim 1, wherein the controller is adapted to:
identify a target temperature for the coolant at a respective inlet of the C2R heat exchanger, in response to input signals indicative of a demand for the cabin heating; and
increase the respective load of the coolant when a coolant temperature at the respective inlet of the C2R heat exchanger is at or above the target temperature.

3. The system of claim 2, wherein the target temperature is between −5 degrees Celsius and −9 degrees Celsius.

4. The system of claim 1, wherein the controller is adapted to:
direct the coolant path to flow through the low-temperature radiator when the coolant temperature at a respective inlet of the low-temperature radiator is less than the ambient temperature; and
direct the coolant path to bypass the low-temperature radiator when the coolant temperature at the respective inlet of the low-temperature radiator is at or above the ambient temperature.

5. The system of claim 1, wherein the controller is adapted to:
increase a compressor load if a low-side refrigerant pressure is at or above the threshold suction pressure; and
decrease the compressor load if the low-side refrigerant pressure is below the threshold suction pressure.

6. The system of claim 1, further comprising:
a rechargeable energy storage system (RESS) section located in the coolant loop downstream of the low-temperature radiator, the RESS section having a traction battery pack, the controller being adapted to:
direct the coolant path to flow through the RESS section when the coolant temperature at a respective inlet of the RESS section is less than a RESS temperature, the coolant receiving heat from the RESS section; and
direct the coolant path to bypass the RESS section when the coolant temperature at the respective inlet of the RESS section is at or above the RESS temperature.

7. The system of claim 1, wherein the threshold suction pressure is between 120 and 140 Kilopascals, and a target load for the compressor is between 4000 and 5000 revolutions-per-minute.

8. The system of claim 1, further comprising:
a power electronics (PE) section located in the coolant loop downstream of the low-temperature radiator; and
wherein the controller is adapted to:
direct the coolant path to flow through the PE section when the coolant temperature at a respective inlet of the PE section is less than a PE section temperature, the coolant receiving heat from the PE section; and
direct the coolant path to bypass the PE section when the coolant temperature at the respective inlet of the PE section is at or above the PE section temperature.

9. The system of claim 1, further comprising:
a surge tank adapted to store additional coolant, the controller being adapted to selectively draw the additional coolant into the coolant loop.

10. The system of claim 1, further comprising:
a condensing heater located in the refrigerant loop downstream of the compressor, the condensing heater being adapted to transmit heat to a vehicle cabin.

11. A method for thermal management in an electric vehicle having a coolant loop and a controller with a processor and tangible, non-transitory memory, the method comprising:
circulating a coolant in the coolant loop via a pump, the coolant loop having one or more valves;
modifying a coolant pathway by controlling a respective position of the one or more valves, via the controller;
transferring heat between the coolant circulating in the coolant loop and a refrigerant circulating in a refrigerant loop through a coolant-to-refrigerant (C2R) heat exchanger fluidly connected to the coolant loop and the refrigerant loop;
extracting heat from ambient air to warm the coolant when a coolant temperature is lower than an ambient temperature through a low-temperature radiator located in the coolant loop downstream of the C2R heat exchanger;
positioning a coolant heater in the coolant loop downstream of the low-temperature radiator and positioning a compressor in the refrigerant loop; and
minimizing energy usage for cabin heating in the electric vehicle by minimizing a respective load of the coolant heater, maximizing the respective load of the compressor, and maintaining a threshold suction pressure for compressor operation, via the controller.

12. The method of claim 11, further comprising:
identifying a target temperature for the coolant at a respective inlet of the C2R heat exchanger in response to input signals indicative of a demand for the cabin heating, the target temperature being between −5 degrees Celsius and −9 degrees Celsius; and
increasing the respective load of the coolant when a coolant temperature at the respective inlet of the C2R heat exchanger is at or above the target temperature.

13. The method of claim 11, further comprising:
directing the coolant path to flow through the low-temperature radiator when the coolant temperature at a respective inlet of the low-temperature radiator is less than the ambient temperature; and
directing the coolant path to bypass the low-temperature radiator when the coolant temperature at the respective inlet of the low-temperature radiator is at or above the ambient temperature.

14. The method of claim 11, further comprising:
increasing a compressor load if a low-side refrigerant pressure is at or above the threshold suction pressure, the threshold suction pressure being between 120 and 140 Kilopascals; and
decreasing the compressor load if the low-side refrigerant pressure is below the threshold suction pressure, a target load for the compressor being between 4000 and 5000 revolutions-per-minute.

15. The method of claim 11, further comprising:
positioning a rechargeable energy storage method (RESS) section in the cooling loop downstream of the low-temperature radiator, the RESS section having a traction battery pack;
directing the coolant path to flow through the RESS section when the coolant temperature at a respective inlet of the RESS section is less than a RESS temperature, the coolant receiving heat from the RESS section; and
directing the coolant path to bypass the RESS section when the coolant temperature at the respective inlet of the RESS section is at or above the RESS temperature.

16. The method of claim 11, further comprising:
positioning a powertrain drive unit (PDU) in the cooling loop downstream of the low-temperature radiator;
directing the coolant path to flow through the PDU when the coolant temperature at a respective inlet of the PDU is less than a PDU temperature, the coolant receiving heat from the PDU; and
directing the coolant path to bypass the PDU when the coolant temperature at the respective inlet of the PDU is at or above the PDU temperature.

17. An electric vehicle comprising:
a coolant loop having a pump configured to circulate a coolant in the coolant loop;
one or more valves adapted to modify a pathway of the coolant in the coolant loop;
a controller adapted to select a respective position of the one or more valves, the controller having a processor and tangible, non-transitory memory on which instructions are recorded;
a refrigerant loop in thermal communication with the coolant loop, the refrigerant loop having a compressor;
a coolant-to-refrigerant (C2R) heat exchanger fluidly connected to the coolant loop and the refrigerant loop, the C2R heat exchanger being configured to transfer heat between the coolant circulating in the coolant loop and a refrigerant circulating in the refrigerant loop;
a low-temperature radiator located in the coolant loop downstream of the C2R heat exchanger, the low-temperature radiator being adapted to extract heat from ambient air to warm the coolant when a respective temperature of the coolant is lower than an ambient temperature;
a coolant heater located in the coolant loop downstream of the low-temperature radiator; and
wherein the controller is adapted to:
identify a target temperature for the coolant at a respective inlet of the C2R heat exchanger, in response to input signals indicative of a demand for cabin heating in the electric vehicle;
increase a respective load of the coolant when a coolant temperature at the respective inlet of the C2R heat exchanger is at or above the target temperature; and
minimize energy usage for the cabin heating by maximizing the respective load of the compressor, minimizing the respective load of the coolant heater, and maintaining a threshold suction pressure for compressor operation.

18. The electric vehicle of claim 17, wherein the controller is adapted to:
direct the coolant path to flow through the low-temperature radiator when the coolant temperature at a respective inlet of the low-temperature radiator is less than the ambient temperature; and
direct the coolant path to bypass the low-temperature radiator when the coolant temperature at the respective inlet of the low-temperature radiator is at or above the ambient temperature.

19. The electric vehicle of claim 17, wherein the controller is adapted to:
increase a compressor load if a low-side refrigerant pressure is at or above the threshold suction pressure; and
decrease the compressor load if the low-side refrigerant pressure is below the threshold suction pressure.

20. The electric vehicle of claim 17, further comprising:
a rechargeable energy storage system (RESS) section located in the coolant loop downstream of the low-temperature radiator, the RESS section having a traction battery pack, the controller being adapted to:
direct the coolant path to flow through the RESS section when the coolant temperature at a respective inlet of the RESS section is less than a RESS temperature, the coolant receiving heat from the RESS section; and
direct the coolant path to bypass the RESS section when the coolant temperature at the respective inlet of the RESS section is at or above the RESS temperature.
